(19) United States
(12) Patent Application Publication
(10) Pub. No.: US 2013/0064954 A1
(43) Pub. Date: Mar. 14, 2013

(54) Microemulsion Concentrates and Nanoemulsion Flavorant Compositions For Food Applications

(71) Applicants: Maria Ochomogo, Pleasanton, CA (US); Ritu Garg, Pleasanton, CA (US); Edith Ramos da Conceicao Neta, Pleasanton, CA (US); Yuming Yang, Pleasanton, CA (US); Lachelle Arnt, Pleasanton, CA (US); Adelmo Monsalve-Gonzalez, Lakeville, MN (US)

(72) Inventors: Maria Ochomogo, Pleasanton, CA (US); Ritu Garg, Pleasanton, CA (US); Edith Ramos da Conceicao Neta, Pleasanton, CA (US); Yuming Yang, Pleasanton, CA (US); Lachelle Arnt, Pleasanton, CA (US); Adelmo Monsalve-Gonzalez, Lakeville, MN (US)

(21) Appl. No.: 13/227,708

(22) Filed: Sep. 8, 2011

(51) Int. Cl. A23L 1/222; B65D 81/34; A23L 1/03; A23L 1/39; A23L 1/09; A23L 1/24; A23L 2/56

(52) U.S. Cl. 426/589; 426/651; 426/590

(57) ABSTRACT

Food nanoemulsion compositions comprising a food safe nonionic surfactant, a hydrophobic food flavorant (e.g., an essential oil), a sugar alcohol kosmotrope, and water. The ratio of the sugar alcohol kosmotrope to the hydrophobic food flavorant is at least 8:1 by weight, and the composition advantageously requires little if any monohydric alcohols for stability and is also free of polyols in addition to the sugar alcohol. Such nanoemulsion compositions are formed from microemulsion concentrates with little or no kinetic energy input. The microemulsion phase inverts to the nanoemulsion upon dilution with additional water. Infinite dilution in water and oil is possible. The high ratio of sugar alcohol to flavorant controls the particle size distribution of the nanoemulsion composition and advantageously alters the organoleptic properties of the nanoemulsion to insert perception of the flavorant near the end of the palatal response.

### THE FIELD OF THE INVENTION

The present invention relates to a food emulsion composition with natural, hydrophobic flavorants. Standard emulsions which have been widely used in food and beverage technology, cosmetics, or pharmaceutical formulations for many years, often appear opaque or cloudy and unstable. In contrast, nanoemulsions, including micellar solutions, are usually transparent dispersions that may be formed spontaneously without the need of energy input, when the compounds thereof are properly mixed with each other. Due to the very small size of dispersed oil-droplets in a nanoemulsion, (e.g., in many cases the dispersed oil-droplets are less than 140 nm in diameter) visible light cannot be scattered and therefore such nanoemulsions appear as clear or translucent isotropic solutions.

A classic oil-in-water microemulsion or nanoemulsion typically includes water, oil, and one or more surfactants and co-surfactants. Typical compositions require at least two different surfactants. Although nanoemulsions can be formed without high kinetic energy input, the selection of components, their relative amounts, and shear flow are critical factors in their formation. Such factors also affect final characteristics such as optical appearance, organoleptic characteristics (e.g., taste and smell), and thermodynamic stability. In addition, when nanoemulsions are used as flavor delivery systems in food products, for example in beverages, sauces, or dressings, they must fulfill all the requirements of these products. For example, such a product should provide excellent shelf-life stability over a large temperature range for a series of months without significant deterioration, rancid odor, or bitter flavor.

### DESCRIPTION OF RELATED ART

Emulsions have been widely used in food and beverage technology, cosmetics, and pharmaceutical formulations for many years. Nevertheless, existing emulsions exhibit several drawbacks, including limited thermodynamic stability. For example, they separate into two distinct liquid phases upon standing. Without being bound by theory, this is believed to occur because such compositions typically require kinetic energy to be input to the system in order to form the emulsion. Such characteristics represent one of the greatest disadvantages of such compositions. Due to their limited stability over time, essentially all known emulsion based products undergo Ostwald ripening, cream formation, and finally phase separation.

Although the prior art may include microemulsions and nanoemulsions, they do not contain the same components and in the same amounts or ratios as the present invention, and more particularly they do not combine them in a way to be thermodynamically stable, they do not extend the anti-oxidation properties of the food products, they do not have an average or median droplet size of less than about 140 nm, less than 100 nm, and more typically between about 50 nm and about 100 nm, and are not configured to provide all the benefits of the present compositions.

Formulating aqueous food emulsions with oil based flavorants can be challenging because such flavorants are not readily miscible in water. In at least some embodiments, it is important that the flavorants be added to the aqueous phase of such food emulsions. As a result, essential oils and other oil based flavorants are often difficult to prepare in a form that will allow them to be readily incorporated into an aqueous solution.

Unlike typical emulsions, microemulsion concentrates and phase inverted nanoemulsions formed therefrom are typically transparent dispersions that form spontaneously without the need for energy input, when the components thereof are properly mixed with each other.

There exists an unmet need for nanoemulsion formulations that are edible, not bitter, substantially clear, thermodynamically stable, that remain stable upon further dilution, that are entirely composed of food grade quality components, which do not require at least two different surfactants, which comprise a relatively low level of surfactant in the finished nanoemulsion, require no additional emulsifiers, do not require the use of monohydric alcohols, various polyols, and which provide organoleptic qualities that are comparable or better than taste and smell characteristics provided by traditional dry spice flavorants. In addition, it would be further advantageous if one could predict the mean or median size distribution of the inverted oil-in-water micelles.

### BRIEF SUMMARY OF THE INVENTION

According to one embodiment, the present invention relates to a natural flavorant food emulsion composition comprising a hydrophobic food flavorant, a food safe non-ionic surfactant that encapsulates the flavorant, a sugar alcohol kosmotrope co-solvent, and water solvent. The food emulsion is initially in the form of a microemulsion concentrate which can be diluted (e.g., with water), causing a phase inversion and formation of the desired nanoemulsion. The concentrated microemulsion may be a water-in-oil emulsion that upon dilution with additional water undergoes micelle inversion, resulting in an oil-in-water nanoemulsion in which the nano-sized micelles exhibit very high curvatures and nano-sized micelles or droplets. This phenomenon is believed to be due to the disturbance of the bicontinuous phase, opening the one-phase region so as to allow the conversion from a water-in-oil microemulsion to an oil-in-water nanoemulsion upon dilution. The nanoemulsion is clear and thermodynamically stable. Due to the very small size of dispersed oil-droplets and the relatively narrow size distribution of the droplets in the nanoemulsions, the visible light cannot be scattered and therefore such nanoemulsions appear as clear or translucent isotropic solutions. This characteristic is maintained, even upon further dilution of the nanoemulsion. This phenomenon that allows infinite dilution while maintaining the isotropic (i.e., clear) nanoemulsion structure is not known to occur in existing nanoemulsions or microemulsions.

In fact, the nanoemulsion is so stable that it can be dried, frozen, or boiled and still maintain its nanoemulsion characteristics. The inventors are not aware of any existing nanoemulsions exhibiting similar characteristics. The encapsulation of the flavorant in the microemulsion concentrate and nanoemulsion structure protects the flavorant from oxidation so that the food emulsion does not deteriorate nearly as rapidly at ambient storage temperatures as compared to traditional non-encapsulated flavorants. In addition, the natural flavorant food emulsion exhibits superior flavor and aroma intensity as compared to non-encapsulated essential oil formulations because of the extremely small micelle size of the oil droplets. For example, due to the large surface area per volume of the nano-size droplets, there is an enhancement effect as to the availability of the flavorant oil to the taste buds. Stated another way, smaller droplet sizes of the oil flavorant result in a higher intensity associated with the flavor.

Furthermore, the relatively narrow size distribution of the droplets about the median and the ability to predict and thus formulate the nanoemulsion so as to provide a desired median droplet size with narrow size distribution allows control over the organoleptic properties associated with an oil flavorant used in the nanoemulsion. In other words, one is able to control when during the palatal response the oil flavorant is sensed by the person tasting a product including the nanoemulsion. The inventors have found that smaller droplet sizes are sensed earlier, while increasing the droplet size delays when during the palatal response the oil flavorant of the nanoemulsion is sensed.

That said, the inventors have also observed that in order to achieve overall organoleptic qualities that are comparable to those provided by traditional dry spice type flavorants, according to one embodiment, the size of the micelle droplets is manipulated to a size that is larger than the smallest size that could be formed by manipulation of the ratio of sugar alcohol to the oil flavorant. For example, although it is possible to achieve median droplet sizes in the 10 nm to 25 nm range, the inventors have found that larger sizes (e.g., about 50 nm to about 100 nm, more preferably about 60 nm to about 80 nm) surprisingly solves deficiencies associated with the organoleptic qualities of nanoemulsions including smaller droplet sizes. Droplet size is increased by providing a ratio of sugar alcohol to oil flavorant that is at least about 8:1 (e.g., between about 8:1 and about 30:1). The higher the ratio, the greater the droplet size.

Such high ratios have been found by the inventors to surprisingly provide organoleptic qualities, particular taste, that is substantially better than lower ratios. For example, at a ratio of at least about 8:1, the garlic and onion oil flavorants are tasted or perceived within the palatal response at or near the end of the palatal response. At lower ratios (e.g., 2:1), these flavors were being perceived too early, near the beginning of the palatal response. It is important for such flavorants to be perceived near the end of the palatal response if the food product nanoemulsion is to substitute for dry spice type flavorants, as this is the type of response provided by such flavorants. Surprisingly, by increasing the sugar alcohol to oil flavorant ratio to at least about 8:1, this problem has been overcome. These levels of the sugar alcohol have also been found to allow a decrease in the level of surfactant while still maintaining a stable nanoemulsion.

Essential oils, oleoresins and oil-based natural flavors may be used as flavoring substances in food type emulsions. These flavor substances are readily miscible in the oil (hydrophobic) phase and, depending on the partition coefficient, negligible amounts of the flavor substances are dissolved in the aqueous (hydrophilic) phase of the food emulsion. As a result, essential oils and hydrophobic flavors must be incorporated with the oil phase, and thus find only limited use as flavorants in oil-in-water emulsions. In addition, essential oils and hydrophobic flavors are prone to deterioration via oxidation.

The use of spontaneously forming, self assembling microemulsion concentrates, and nanoemulsions formed by diluting such microemulsion concentrates, to encapsulate hydrophobic flavorants permits the dispersion of the hydrophobic flavoring substances into the aqueous phase of the food emulsion (e.g., a salad dressing), so placement within the oil phase of a salad dressing or other food emulsion is not necessary. Surprisingly, the encapsulation and dispersion of the flavors into the aqueous phase of the food type emulsions augment or enhance their flavoring intensities up to three fold when compared to their non-encapsulated counterparts. The microemulsion concentrate and nanoemulsion encapsulated structures also protect the flavoring substances against oxidation by creating a physical barrier that impedes or minimize their interaction with any oxygen present (e.g., in the aqueous phase of the food emulsion).

According to one embodiment, the food emulsion composition comprises a hydrophobic food flavorant (e.g., an essential oil), a food safe nonionic surfactant, water, and a sugar alcohol (e.g., sorbitol, xylitol, arabitol, lactitol, maltitol, glycerol, mannitol, isomalt, erythritol, dulcitol, iditol, polyglycitol, and mixtures or combinations thereof). The ratio of the sugar alcohol to the hydrophobic flavorant is at least 8:1 by weight. Embodiments where the weight ratio of the sugar alcohol to the hydrophobic flavorant ranges anywhere from 8:1 to 50:1 are expressly considered part of the present invention. For example, examples of embodiments of the present invention include sugar alcohol to hydrophobic flavorant weight ratios from 8:1 to 30:1, from 8:1 to 15:1, from 10:1 to 15:1, as well as specific ratios such as 8:1, 10:1 or 15:1. The inventors have found that although high weight ratios of sugar alcohol to hydrophobic flavorant such as 30:1 may successfully be employed, similar results may be achieved at lower costs by using lower sugar alcohol to hydrophobic flavorant weight ratios such as 15:1. Advantageously, in one embodiment the composition is substantially free from polyol solvents other than the sugar alcohol (e.g., no propylene glycol). The composition may also be substantially free or entirely free of monohydric alcohols (e.g., lower alcohols such as ethanol, methanol, isopropanol, n-propanol, t-butanol, etc.). For example, in one embodiment, no more than about 5% of such a monohydric alcohol is included. In another embodiment, no such monohydric alcohol is included.

In one embodiment, the flavorant component is present at levels from about 0.1% to about 15% by weight of the nanoemulsion composition. Embodiments where the flavorant component is present at levels at any range within about 0.1% to about 15% by weight of the nanoemulsion composition are expressly considered part of the present invention. For example, the present invention includes embodiments where the flavorant component is present at levels from 0.5% to 15%, 2% to 15%, 5% to 13%, 5% to 10%, 0.1 to 2%, 0.25% to 1% and 0.3% to 1% by weight of the nanoemulsion composition.

In one embodiment, the level of sugar alcohol co-solvent is present at levels between about 1% and about 30% by weight of the nanoemulsion composition. Embodiments where the sugar alcohol co-solvent is present at levels at any range within about 1% to about 30% by weight of the nanoemulsion composition are expressly considered part of the present invention. For example, the present invention includes embodiments where the sugar alcohol co-solvent is present at levels from 5% to 25%, 10% to 20%, 10% to 15%, and 8% to 15% by weight of the nanoemulsion composition.

The food safe surfactant may be present at virtually any level. The present invention includes embodiments where the level of food safe surfactant is at least about 5% by weight of the nanoemulsion composition. Embodiments where the food safe surfactant is present at any level equal to or greater than about 5% by weight of the nanoemulsion composition are expressly considered part of the present invention. For example, the present invention includes embodiments where the food safe surfactant is present at a level of at least 20%. The present invention also includes embodiments where the food safe surfactant is present at a levels ranging from 25% to 63% and 25% to 50%. In other embodiments, the food safe surfactant is provided at significantly lower levels of not more than 20%, not more than 15%, not more than 10% and not more than 5%. Of course, if the nanoemulsion composition is further added to a food product, the levels of surfactant as a percentage of the overall food product will be considerably lower.

The nonionic surfactant(s) selected preferably have a hydrophilic-lipophilic balance (HLB) greater than about 10, more preferably a HLB of about 13 or greater. The balance of the nanoemulsion composition may be water. The amount of water in the nanoemulsion may be greater than about 40% by weight, more preferably greater than 50% by weight and most preferably greater than 55% by weight.

In exemplary embodiments of the invention, the nanoemulsion is created so that there is about 0.1% to about 15% by weight of hydrophobic flavorant and that there is at least about eight (8) times as much sugar alcohol co-solvent as flavorant (by weight), i.e., the weight ratio of sugar alcohol co-solvent to flavorant is at least about 8:1 by weight. There is at least about five times as much food safe nonionic surfactant as the flavorant (by weight); thus the weight ratio of food safe nonionic surfactant to flavorant is at least about 5:1 by weight. In such an exemplary embodiment the weight ratio of sugar alcohol co-solvent to flavorant is within 8:1 to 15:1 and the weight ratio of food safe nonionic surfactant to flavorant is within 5:1 to 20:1.

As described, the food emulsion provides for a novel and completely natural food emulsion composition, which exhibits excellent taste and stability properties. In addition, the inventors have found that the particular organoleptic qualities of the food emulsion may be manipulated through the particular weight ratio of sugar alcohol to hydrophobic flavorant. For example, in the context of a salad dressing, it may be desirable for the onion and/or garlic oil flavorants to be perceived at or near the end of the palatal response. Traditional salad dressing formulations including dry spice type flavorants exhibit such a characteristic. The inventors have found that where the weight ratio of sugar alcohol to flavorant is too low and droplet size too small, then the onion and/or garlic oil flavorants are perceived too early during palate response. By increasing the weight ratio of sugar alcohol to flavorant, the droplet size of the oil flavorants actually increases, and the flavor perception of the onion and garlic flavors is surprisingly and unexpectedly pushed later in the palate response.

The food emulsion composition is in the form of a stable and clear microemulsion concentrate or nanoemulsion formed by dilution and phase inversion of the microemulsion concentrate. Disclosed herein are microemulsion concentrates formed by mixing of an oil phase (flavorant), a food safe nonionic surfactant that encapsulates the oil phase, and an aqueous phase (water). The microemulsion concentrates form spontaneously (i.e., without the need for high kinetic energy input) and create a nano self-structured liquid (NSSL) (i.e., a nanoemulsion) upon dilution with additional water. The NSSL is thermodynamically stable over a wide range of temperatures (e.g., it can be boiled, frozen, and even dried while maintaining encapsulation stability) and has a median droplet size in the size range of about 10 nm to about 200 nm, preferably from 10 nm to 100 nm and more preferably from 50 nm to 100 nm. While it is possible to achieve smaller median droplet sizes (e.g., 10 nm to 50 nm) by omitting or reducing the amount of sugar alcohol relative to the hydrophobic flavorant, this is undesirable at least in the context of onion and garlic oils in salad dressings where the inventors have found that smaller droplet sizes result in these flavors being perceived too early. Slightly increasing the median droplet size (e.g., 50 nm to 100 nm) actually moves the perception of these flavors later in the palate response. At these droplet sizes, the NSSL is aesthetically clear, and is stable upon dilution, drying, freezing, and boiling.

The features and advantages of embodiments of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

References herein to “one embodiment”, “one aspect” or “one version” of the invention include one or more such embodiment, aspect or version, unless the context clearly dictates otherwise.

As used in this specification and the appended claims, the singular forms “a”, “an”, and “the” include plural referents unless the context clearly dictates otherwise.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the active composition alone. Each of the noted food emulsion composition components is discussed in detail below.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

The precise definition of a “flavorant” is difficult since its literal definition includes anything that contributes flavor to food. A legal definition by the U.S. Code of Federal Regulations, a natural flavorant is: “the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional.”

The term flavorant includes such natural flavorants, and includes, but is not limited to, essential oils, oleoresins, oil-based natural flavors and mixtures and combinations thereof. An “essential oil” is any concentrated, hydrophobic liquid containing volatile aroma compounds from plants. Essential oils are natural products commonly used in foods and beverages for their fragrance and taste properties. “Oleoresins” are a naturally occurring mixture of an oil and a resin extracted from various plants. Any other suitable oil-based natural flavors are included in the term “hydrophobic food flavorant”.

The term “food safe” refers to compositions, which are comprised entirely of materials that are considered food grade, and/or Generally Recognized As Safe (GRAS) and/or Everything Added to Food in the U.S. (EAFUS). In the United States, ingredients pre-approved for food use are listed in the United States Code of Federal Regulations (“C.F.R.”), Title 21. The term “food safe” includes compositions that are both safe and suitable for direct application to food work surfaces, including but not limited to, cutting boards, sinks, and kitchen counter tops, as well as direct food contact surfaces, including but not limited to, plates, platters and silverware. Food safe materials may also include ingredients that are well established as safe, or have adequate toxicological and safety pedigree, can be added to existing lists or approved via a self-affirmation process.

### II. Introduction

According to one embodiment, a food emulsion composition comprises a hydrophobic food flavorant, a food safe nonionic surfactant for encapsulating the flavorant, water solvent, and a sugar alcohol (e.g., sorbitol, xylitol, arabitol, lactitol, maltitol, glycerol, mannitol, isomalt, erythritol, dulcitol, iditol, polyglycitol, and mixtures or combinations thereof). The ratio of the sugar alcohol to hydrophobic flavorant is at least about 8:1 by weight. The present invention includes embodiments where the weight ratio of sugar alcohol to hydrophobic flavorant ranges from 8:1 to 50:1. Embodiments where the weight ratio of sugar alcohol to hydrophobic flavorant is anywhere within the range of 8:1 to 50:1 are expressly considered part of the present invention. For example, the present invention includes embodiments where the weight ratio of sugar alcohol to hydrophobic flavorant ranges from 8:1 to 30:1 and from 8:1 to 15:1. Advantageously, in one embodiment the composition is substantially free from polyol solvents other than the sugar alcohol (e.g., no propylene glycol). The composition may also be substantially free of monohydric alcohols.

The food emulsion composition is in the form of a stable and clear microemulsion concentrate or nanoemulsion formed by dilution and phase inversion of the microemulsion concentrate. The microemulsion concentrate forms spontaneously (i.e., without the need for high kinetic energy input) upon addition of ingredients in the prescribed order and creates a nano self-structured liquid (NSSL) (i.e., a nanoemulsion) upon dilution with additional water. The NSSL is thermodynamically stable over a wide range of temperatures (e.g., it can be boiled, frozen, and even dried). For example, a nanoemulsion including a hydrophobic food flavorant that is incorporated into a food product to provide a desired flavor will exhibit a median droplet size from about 50 nm to about 100 nm. While it is possible to achieve smaller droplet sizes (e.g., 10 nm to 50 nm) by omitting or reducing the amount of sugar alcohol relative to the hydrophobic flavorant, this may be undesirable as the smaller droplet sizes may result in the flavor being perceived too early. For example, in the context of onion and garlic oils in salad dressings, the inventors have found that increasing the median droplet size from a range of 10 nm to 50 nm to a range of 50 nm to 100 nm actually moved the perception of these flavors later in the palatal response.

### III. Flavorants

Any suitable hydrophobic food flavorant may be employed in the present microemulsion concentrates and nanoemulsions formed therefrom by dilution. According to one embodiment, the flavorant component is present at levels ranging from about 0.1% to about 15% by weight of the nanoemulsion. Embodiments where the hydrophobic food flavorant is present at any level from 0.1%-15% by weight of the nanoemulsion composition are expressly considered part of the present invention. For example, the present invention includes embodiments where the flavorant component is present at levels from 0.5%-15%, 2%-15%, 5%-13%, and 5%-10% by weight. In some embodiments (e.g., including onion oil or garlic oil flavorants), the range may be from 0.1%-2%, 0.25%-1%, or 0.3%-1% by weight. Where two flavorants are included (e.g., both onion and garlic), these ranges may be for each individual flavorant or for the combination of flavorants (e.g., if the hydrophobic food flavorant is present at 2% and the flavorant comprises the combination of garlic oil and onion oil, then each may be present at 1%).

The weight ratio of the sugar alcohol to the flavorant should be at least about 8:1 and can be as high as about 50:1. Embodiments where the weight ratio of the sugar alcohol to the flavorant is anywhere within the range of 8:1 and 50:1 are expressly considered part of the present invention. For example, the present invention includes embodiments where the weight ratio of sugar alcohol to flavorant ranges from 8:1 to 50:1, 8:1 to 30:1, and 8:1 to 15:1. As mentioned, the inventors have discovered that by increasing the amount of sugar alcohol relative to flavorant, the median droplet size of the nanoemulsion is increased. In one embodiment, the ratio of sugar alcohol to flavorant can be selected to insert the flavorants into the palatal response where desired (e.g., smaller droplet sizes tend to insert the flavorant notes into the palatal response earlier).

Such flavor substances are readily miscible in the oil phase of emulsions or two-phase mixtures. Depending on the partition coefficient, negligible amounts of the hydrophobic flavor substances are dissolved in the aqueous hydrophilic phase of existing food emulsions. As a result, essential oils, oleoresins, and other hydrophobic flavors find only limited use in flavoring oil in water emulsions, or they have been required to be incorporated with the oil phase of existing formulations. In addition, essential oils, oleoresins, and other hydrophobic flavorants are prone to deterioration via oxidation. By way of contrast, embodiments of the present inventive nanoemulsions formed by dilution and phase inversion of microemulsion concentrates permit the dispersion of the hydrophobic flavoring substances into the aqueous phase of an oil and water food product, e.g., a salad dressing. For instance, when a nanoemulsion is mixed into an oil and water salad dressing, the hydrophobic flavorant droplets encapsulated by the surfactant actually reside within the aqueous phase, rather than the oil phase of the oil and water dressing or other food product. This allows such hydrophobic flavorants, such as essential oils and oleoresins to be used to provide a flavor to the aqueous phase of such a food product. In addition, using essential oils, oleoresins, or other hydrophobic flavorants rather than dry spices (e.g., dried onion and garlic) to flavor the food product decreases or eliminates the microbial load and associated risk associated with the use of such dry spices.

Significantly less of the flavorant is required (e.g., the weight fraction of flavorant may be reduced by a factor of two, three, or more) as compared to flavoring with dry spice type flavorants or with very large droplet size emulsions. This is because encapsulation and nano droplet dispersion of the hydrophobic flavorants into the aqueous phase enhances the flavoring intensity of the flavorant significantly as a result of the nano-sized droplet structure of the flavorant oil. Furthermore, the degradation prone flavorants are encapsulated by a surfactant, minimizing or preventing their interaction and degradation by any oxygen in the aqueous phase of, for example, the salad dressing, or other food product.

The essential oils preferred for use in aqueous compositions are those essential oils which can form a microemulsion concentrate when combined with a nonionic surfactant and a water phase. Suitable essential oils include, but are not limited to, those obtained from onion, garlic, oregano, mint, tea tree, parsley, thyme, lemongrass, lemons, limes, grapefruit, oranges, anise, clove, roses, lavender, citronella, eucalyptus, peppermint, camphor, sandalwood, cedar and pine.

Other suitable essential oils include, but are not limited to: Anethole 20/21 natural, Aniseed oil china star, Aniseed oil globe brand, Balsam (Peru), Basil oil (India), Black pepper oil, Black pepper oleoresin 40/20, Bois de Rose (Brazil) FOB, Borneol Flakes (China), Camphor oil, White, Camphor powder synthetic technical, Cananga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Coumarin 69° C. (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrette, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), Wintergreen, Allocimene, ARBANEX, ARBANOL, Bergamot oils, Camphene, Alpha-Campholenic aldehyde, I-Carvone, Cineoles, Citral, Citronellol Terpenes, Alpha-Citronellol, Citronellyl Acetate, Citronellyl Nitrile, Para-Cymene, Dihydroanethole, Dihydrocarveol, d-Dihydrocarvone, Dihydrolinalool, Dihydromyrcene, Dihydromyrcenol, Dihydromyrcenyl Acetate, Dihydroterpineol, Dimethyloctanal, Dimethyloctanol, Dimethyloctanyl Acetate, Estragole, Ethyl-2 Methylbutyrate, Fenchol, FERNLOL, FLORILYS, Geraniol, Geranyl Acetate, Geranyl Nitrile, GLIDMINT Mint oils, GLIDOX, Grapefruit oils, trans-2-Hexenal, trans-2-Hexenol, cis-3-Hexenyl Isovalerate, cis-3-Hexanyl-2-methylbutyrate, Hexyl Isovalerate, Hexyl-2-methylbutyrate, Hydroxycitronellal, Ionone, Isobornyl Methylether, Linalool, Linalool Oxide, Linalyl Acetate, Menthane Hydroperoxide, 1-Methyl Acetate, Methyl Hexyl Ether, Methyl-2-methylbutyrate, 2-Methylbutyl Isovalerate, Myrcene, Nerol, Neryl Acetate, 3-Octanol, 3-Octyl Acetate, Phenyl Ethyl-2-methylbutyrate, Petitgrain oil, cis-Pinane, Pinane Hydroperoxide, Pinanol, Pine Ester, Pine Needle oils, Pine oil, alpha-Pinene, beta-Pinene, alpha-Pinene Oxide, Plinol, Plinyl Acetate, Pseudo lonone, Rhodinol, Rhodinyl Acetate, Spice oils, alpha-Terpinene, gamma-Terpinene, Terpinene-4-OL, Terpineol, Terpinolene, Terpinyl Acetate, Tetrahydrolinalool, Tetrahydrolinalyl Acetate, Tetrahydromyrcenol, TETRALOL, Tomato oils, Vitalizair, ZESTORAL.

The flavorant may include an oleoresin. Suitable types of oleoresins include, but are not limited to, onion, garlic, oregano, basil, black pepper, capsicum, cardamom, celery seed, clove, coriander, cumin, fennel, fenu Greek, ginger, chili, green pepper, nutmeg, anise, tumeric, vanilla, paprika, and others which can be included in food emulsions.

In addition to essential oils and oleoresins, the flavorant may include other natural oil-based flavorants. The flavorant in the emulsion composition may include any mixtures or combinations of essential oils, oleoresins and other natural oil-based flavorants. By way of example, a nanoemulsion for use in preparing a salad dressing may include garlic oil and/or onion oil. Separate nanoemulsions for separate flavorants may also be provided for combination into a food product (e.g., one nanoemulsion for onion oil, another for garlic oil).

### IV. Nonionic Surfactant

The level of nonionic surfactant useful in the present invention is determined by the amount of flavorant used, and also by the levels deemed acceptable as food safe. According to one embodiment, the nonionic surfactants included in nanoemulsions of the present invention are present at levels of from at least about 3%, by weight of the composition. Embodiments where the nonionic surfactants are present at any level within 3%-25% by weight of the nanoemulsion composition are expressly considered part of the present invention. For example, the present invention includes embodiments where the nonionic surfactants are present preferably from 5%-25%, more preferably from 5%-20% and most preferably from 10%-20%. In one embodiment of the invention, the weight ratio of nonionic surfactant to flavorant ranges from 5:1 to 50:1. Embodiments where the weight ratio of nonionic surfactant to flavorant falls anywhere within the range of 5:1 and 50:1 are expressly considered part of the present invention. For example, the nanoemulsion may include about 1% flavorant and about 20% nonionic surfactant by weight.

The one or more nonionic surfactants selected preferably have a hydrophilic-lipophilic balance (HLB) greater than about 10, more preferably a HLB of about 13 or greater. HLB values of less than 10 are indicative of solubility in lipids. HLB values greater than 10 are indicative of solubility in water. The selected range of HLB values greater than 10 allows the surfactant to be mixed with the hydrophobic flavorant, encapsulating the oil. The sugar alcohol co-solvent is then added, breaking the lamellar phase. A portion of the water is then added, resulting in a microemulsion water-in-oil concentrate. Upon addition of further water, the phases invert, forming an oil-in-water nanoemulsion with nano-sized micelles.

The HLB value of a nonionic surfactant blend is the weighted average of the blended surfactants. As such, in some embodiments, a surfactant having an HLB value less than 10 may be used, where it is also paired with another surfactant having a higher HLB value. Although such is possible, it is preferred to formulate compositions where only a single surfactant is needed. A HLB value of 10 or greater aids in forming a translucent or clear nanoemulsion, as desired. A high HLB value is also desirable for an aqueous composition because the higher the HLB the more hydrophilic the surfactant. Therefore oil-in-water emulsions, like some embodiments of the present invention, typically require a nonionic surfactant with a medium to high value.

In one embodiment of the invention, suitable nonionic surfactants have a pour point of about 20° F. and are viscous, but pourable at a temperature range of about 34-40° F. In one embodiment of the invention, the nonionic surfactants are food safe surfactants, including but not limited to, polysorbates, polyglycerol esters, glycosides, sorbitan esters, ethoxylated sorbitan esters, sorbitan tristreate, monoglycerides, sucrose esters, ethoxylated castor oils, and combinations thereof. As the composition will be ingested, specific surfactants selected should be stable and not impart an “off” (e.g., oily) flavor to the food product (e.g., a salad dressing). Polysorbates, specifically polyoxyethylene sorbitan monolaurate (i.e., commercially available as TWEEN 20) is one surfactant that has been found to meet these requirements.

Surfactants, such as a phospholipid in the form of lecithin, may also act as flavor stabilizers and promote uniformity of the flavor transfer. Lecithin only has a HLB value of about 6-8, and therefore if included, is included as an optional surfactant in addition to one having a higher HLB value. Such optional surfactants may be present in amounts from 0 to about 1% or more based upon the weight of the flavorant component. However, the use of these optional surfactants (such as lecithin) as stabilizers, etc. will generally not be needed. In one embodiment, such optional surfactants are not included.

Other optional surfactants may include those surfactants which act as wetting agents or shirring lubricants. Non-limiting examples of such surfactants include water dispersible or at least partially water-soluble surfactants such as alkylene oxide adducts of either fatty acids or partial fatty acid esters, for example, ethoxylated fatty acid partial esters of such polyols as anhydrosorbitols, glycerol, polyglycerol, pentaerythritol, and glucosides, as well as ethoxylated monodiglycerides, sorbitan trioleate, lecithin, and aliphatic polyoxyethylene ethers such as polyoxyethylene (23) lauryl ether.

Preferred surfactants having HLB values greater than 10 include polysorbates, for example polyoxyethylene sorbitan fatty acid esters or mixtures thereof such as those sold under the trademark TWEEN, ethoxylated monodiglycerides or mixtures thereof such as those sold under the trademark MAZOL 80 MG K (commercially available from Mazer Chemical, Inc. of Gurnee, Ill.), and sorbitan trioleate (commercially available from ICI Americas Inc. under the trademark SPAN 85). TWEEN 20 (polyoxyethylene sorbitan monolaurate) is a suitable TWEEN product. TWEEN 60 (polyoxyethylene sorbitan monostearate) and TWEEN 80 (polyoxyethylene sorbitan monooleate) can be used to form nanoemulsions, but are not preferred because they leave an “oily” aftertaste when incorporated into a food product (e.g., a salad dressing). TWEEN 20 includes a carbon chain length of 12, while TWEEN 60 and TWEEN 80 include carbon chain lengths of 18. Thus, other suitable surfactants may include a carbon chain length preferably between 6 and 12. Glycoside surfactants may represent another class of suitable surfactants. Alkyl polyglycoside surfactants may have linear or branched alkyl groups. Suitable alkyl polyglycoside surfactants preferably include a linear alkyl group. Preferably, the alkyl polyglycoside has about 6-22 carbons, more preferably about 6-12 carbons, even more preferably 6-10 carbons and most preferably 8-10 carbons.

The microemulsion concentrates created with an essential oil, TWEEN, a sugar alcohol, and water often result in an exothermic release of heat upon dissolution. Previous experiments conducted by the inventors have indicated that both the TWEEN and the sugar alcohol are responsible for the exothermic reaction that results when the components are mixed.

The enthalpy change of solution is the quantity of heat produced or absorbed when a one mole of a substance is dissolved in a large volume of a solvent at constant pressure. In strong dipole interactions, the solute-solvent interaction may exceed the solvent-solvent interaction, resulting in excess energy in the form of heat. The dissolution process is termed an exothermic reaction with a negative heat of solution. The heat of solution of a substance is defined similarly: by energy absorbed, or endothermic energy, and energy released, or exothermic energy (expressed in “negative” kJ/mol). The heat of solution is one of the three dimensions of solubility analysis because a large negative heat of solution associated with exothermic reactions correlates to increased solubility. The generation of heat as the food emulsion composition is diluted with water is beneficial for a number of reasons. For example, the increase in heat upon dilution of the microemulsion concentrate may aid in the stability of the nanoemulsion at the time of formation.

### V. Water and Co-Solvents

The majority of the finished nanoemulsion (i.e., after final dilution of the microemulsion concentrate) comprises water. In addition, the essential oil, nonionic surfactant, sugar alcohol, and water components can spontaneously form a microemulsion concentrate upon proper addition of the components as explained above. These qualities allow the composition to be formulated either as a concentrate that would be used to add to a food emulsion prior to use or as a more dilute food emulsion product where the flavorant is added in a ready to use product. In one embodiment, a relatively more concentrated nanoemulsion could be added to a sauce to add flavors such as garlic, onion, and/or basil. In another embodiment, a food emulsion composition could be added to an existing food composition including but not limited to, a dressing, a sauce, marinade, or the like, the water may be at least 40% by weight of the composition, preferably at least 50% and more preferably at least 55%. In the case of a concentrated food emulsion composition which is ready to use, the amount of water may be less than about 60%, by weight of the composition, preferably less than about 50% of the composition, and more preferably less than about 40% of the composition.

When added to a salad dressing including both aqueous and oil phases, the inventors have confirmed through confocal Raman spectroscopy that the nanoemulsion resides in the aqueous phase. This fact is important as it affects the organoleptic qualities of the salad dressing that include the nanoemulsion. As discussed previously, it is desirable that the garlic and/or onion oil of the nanoemulsion be perceived at or near the end of the palatal response. In other words, when tasting such a dressing (e.g., a “Ranch” dressing), the person perceives creamy notes, followed by sweet dairy notes, followed by sugar notes, followed by salty notes, followed by vinegar notes, followed by buttermilk notes, with the garlic and onion notes coming at or near the end of the palatal response.

In order to aid in providing the proper palatal response and in providing a stable nanoemulsion, the food emulsion composition includes a sugar alcohol co-solvent. Suitable sugar alcohols may be C₆-C₁₂ sugar alcohols, which include, but are not limited to, sorbitol, xylitol, lactitol, maltitol, mannitol, isomalt, erythritol arabitol, glycerol, dulcitol, iditol, polyglycitol and mixtures or combinations thereof.

In one embodiment of the invention, the food emulsion composition is substantially free of monohydric alcohols, including but not limited to ethanol, methanol, propanol (e.g., isopropanol and n-propanol), glycerol, and t-butanol. Limiting or eliminating the use of such materials is advantageous as such materials have relatively high flammability hazards and thus can be difficult to work with. In addition, their incorporation into foods can be undesirable from a labeling and consumer demand standpoint, particularly where there is a desire for more natural, “clean” ingredients. For example, in one embodiment, no more than about 5% of such a monohydric alcohol is included. In another embodiment, no such monohydric alcohol is included.

Furthermore, according to one embodiment, no polyols other than the sugar alcohol are included. (e.g., propylene glycol and other polyols are excluded). Besides propylene glycol, other non-limiting examples of excluded polyols include, but are not limited to, glycerin, 1,3-propanediol, 1,3-propanetriol, ethylene glycol, and mixtures thereof. The sugar alcohol is present in a weight amount that is at least eight times that of the hydrophobic flavorant, more typically in a weight ratio from about 8:1 to about 15:1. The sugar alcohol may be present at much higher weight ratios e.g., about 30:1. For example, where 1% oil flavorant is present, the sugar alcohol may be present at 30% by weight.

### VI. Buffers

Optionally, buffering and pH adjusting agents, can be added to the food emulsion composition. Suitable food grade buffers include, but are not limited to, organic acids, mineral acids, alkali metal and alkaline earth salts of silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2-methylpropanol. Additional buffering agents for compositions of this invention include nitrogen-containing materials. Some examples are amino acids such as lysine or lower alcohol amines like mono-, di-, and tri-ethanolamine. Other nitrogen-containing buffering agents are tri(hydroxymethyl) amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Other suitable buffers include potassium citrate, ammonium carbamate, citric acid, and acetic acid. Mixtures of any of the above are also acceptable. In one embodiment of the invention the food emulsion composition contains only citric acid or citrate buffers and is essentially free from any other types of buffers. Useful inorganic buffers/alkalinity sources include ammonia, the alkali metal carbonates and alkali metal phosphates, e.g., sodium carbonate, sodium polyphosphate. For additional buffers see McCutcheon's Emulsifiers and Detergents, North American Edition, 1997, McCutcheon Division, MC Publishing Company Kirk and WO 95/07971, both of which are incorporated herein by reference.

When employed, the builder or buffer comprises at least about 0.001% and typically about 0.01-10% of the food emulsion composition. Preferably, the pH adjusting agent or buffer content is 0.01-5% and more preferably from 0.05%-2%.

### VII. Additional Adjuvants

In a further aspect of the present invention, the food emulsion composition optionally includes one or more adjuncts. The adjuncts include, but are not limited to, fragrances, dyes and/or colorants, natural and artificial flavorants, vitamins and minerals, solubilizing materials, stabilizers, thickeners, foam controlling agents, hydrotropes, and/or mineral oils, enzymes, cloud point modifiers, preservatives, polymers and any combinations thereof.

The solubilizing materials, when used, include, but are not limited to, hydrotropes (e.g. water soluble salts of low molecular weight organic acids such as the sodium and/or potassium salts of xylene sulfonic acid). The acids, when used, include, but are not limited to, organic hydroxy acids, acetic acid, adipic acid, ascorbic acid, benzoic acid, lactic acid, phosphoric acid, oleic acid, malic acid, potassium acid tartrate, citric acids, keto acid, and the like. Thickeners, when used, include, but are not limited to, acacia, agar, xanthan gum, cornstarch, calcium carbonate, gelatin, gum tragacanth, starches, pectins, carrageenan, clays, beeswax, gellan gum, guar gum, alginates and any other food safe thickeners.

Foam controlling agents, when used, include, but are not limited to, acacia, silicones and other suitable defoamers. Enzymes, when used, include, but are not limited to, lipases and proteases, and/or hydrotropes and/or toluene sulfonates. Preservatives, when used, include, but are not limited to, acetic acid, adipic acid, ascorbic acid, butylated hydroxyanisole, butylated hydroxytoluene, EDTA, citric acid, calcium propinatesmethyl, ethyl and propyl parabens, short chain organic acids (e.g. acetic, lactic and/or glycolic acids), and/or short chain alcohols (e.g. ethanol and/or IPA).

According to one method of formulation, a hydrophobic flavorant is first encapsulated in a nonionic surfactant. A sugar alcohol is then added to break the lamellar phase, and part of the water is added to form a concentrated microemulsion. At this point, the composition may comprise a water-in-oil microemulsion. Upon dilution with additional water, the phases invert, and the hydrophobic flavorant encapsulated by the surfactant assumes a nano-sized structure of nano-sized droplet sizes. No significant kinetic energy (or heat) input is required in order to form the desired microemulsion concentrates and phase inverted nanoemulsions. Upon addition of the hydrophobic flavorant, the nonionic surfactant, the sugar alcohol, and the water in the prescribed order, a thermodynamically stable phase inversion nanoemulsion is spontaneously formed. The nanoemulsions form spontaneously and create a NSSL that is thermodynamically stable over a wide range of temperatures and includes, on average, droplets in the size range of about 50 nm to about 100 nm, preferably with a median droplet size between about 60 nm and about 80 nm for an embodiment of a hydrophobic food flavorant encapsulated within a surfactant having an HLB greater than 10 for incorporation into a food product in which the flavors or notes are to be perceived at or near the end of the palatal response.

The inventors have found that although the nanoemulsions can be formulated with even smaller droplet sizes, this is often undesirable at least in the above described embodiment because the smaller droplet size causes the flavors or notes from the hydrophobic food flavorant to be perceived near the beginning of the palatal response, rather than at or near the end of the palatal response. It is believed that the larger droplet size exhibits a relatively greater surface tension than the smaller droplet sizes, which slows the flavor release into the taste buds of the person eating the food product that contains the nanoemulsion.

The inventors have surprisingly found that one may manipulate the median droplet size by providing at least eight times as much sugar alcohol as hydrophobic flavorant. In some embodiments, the weight ratio of sugar alcohol to hydrophobic flavorant may be as high as about 30:1, although more typically the ratio may range from 8:1 to 15:1.

Even at these somewhat higher droplet sizes (e.g., a median between 60-80 nm or even 100 nm) the NSSL is substantially clear, and maintains these characteristics upon further dilution. These qualities allow the composition to conceivably be formulated as a concentrate that could be diluted by the user just prior to use (e.g., added to dressings, sauces, etc.) to provide a desired flavor. Of course, these qualities also allow the nanoemulsion to be incorporated into a ready to use food product in which the flavor is provided by the nanoemulsion. Additional flavoring can be provided through other means (e.g., the use of dry type spices). The NSSL is thermodynamically stable to the point that it can be frozen and rethawed, boiled, or dried and then reconstituted while continuing to maintain its nanoemulsion characteristics.

The nano-sized droplets or micelles may exhibit a median size of less than 100 nm but are very stable, exhibiting thermodynamic stability and behavior like a much larger, swollen micelle. Other nanoemulsions often require the addition of co-emulsifiers of similar chain length and often high shear (e.g., a microfluidizer) in order to form a nanoemulsion exhibiting even an acceptable degree of stability. Such nanoemulsions typically will not withstand freezing, boiling, drying, or even dilution. In contrast, embodiments of the nanoemulsions of the present invention do not require additional emulsifiers, surfactants, or microfluidizers in order to achieve stability at a median droplet size of about 100 nm or less. The micelles are spontaneously formed due to the ingredients employed, the order of addition, and are extremely stable, able to withstand freezing, boiling, drying, and dilution.

The distribution of droplet sizes may be relatively narrow. For example, for an average or median droplet size of about 70 nm, at least about 70% of the droplets may lie within ±20% of this value. More generally, at least about 50% and more preferably, at least about 75% of the droplets may lie within ±40% of this value.

The NSSL may be infinitely dilutable in oil and in water while maintaining the single phase emulsion including nano-sized droplets. The NSSL forms a clear and transparent liquid that produces no precipitates, crystalline matter, or turbidity. The nanoemulsion (and microemulsion concentrate) may be of relatively low viscosity (e.g., less than about 100 centipoise, more typically less than about 30 centipoise) and is thermodynamically stable (i.e, it does not separate, coalesce, aggregate, flocculate, or cream at storage temperatures (e.g., about 35° F. to about 100° F., typically about 70° F.), even after prolonged (e.g., a year or more) storage.

The food emulsion compositions can be packaged in any suitable materials and housings known to one skilled in the art. In one embodiment, the nanoemulsion may be incorporated into a salad dressing or sauce. Confocal Raman spectroscopy performed by the inventors has confirmed that the nanoemulsion (including hydrophobic flavorants such as onion oil and garlic oil) resides in the water phase of a oil/water salad dressing. Because the nanoemulsion resides in the water phase rather than the oil phase of the salad dressing, this also aids in providing the desired palatal response in which the onion and garlic flavors or notes are perceived towards the end of the response, rather than at or near the beginning of the palatal response.

Alternatively, the nanoemulsion may be packaged as a concentrate in suitable containers or in ready-to-use dispensing systems. Thus they can be packaged in aerosol form in conventional aerosol containers or in liquid form in trigger pump spray bottles and squeeze bottles or pump spray bottles to produce an aerosol using a pump mechanism to build the necessary pressure to produce the aerosol. The compositions can also be impregnated into substrates, including but not limited to, grains, meats, fluids, gels, or breads. These impregnated substrates can be packaged individually or in bulk form for individual consumption.

In another embodiment, the nanoemulsion may be dried and provided in a dried form (e.g., as a powder). Even when dried, the nano-sized droplets of oil flavorant remain encapsulated and protected by the surfactant. Upon rehydration or contact with water, the encapsulated oils of the dried nanoemulsion may be released to provide a desired flavor to any food that the dried powder is added to.

The nanoemulsion compositions disclosed herein can be used effectively in large-scale industrial food and beverage production, in smaller-scale commercial production or for individual uses for individual consumption on an as desired basis. Such nanoemulsion compositions have wide-ranging applicability, as they can be used in a broad array of food applications and offer the benefits of being safe, stable for long periods of time and cost efficient.

### VIII. Comparative and Exemplary Formulations

Comparative food grade nanoemulsions made using TWEEN 80 and relatively high levels of ethanol are shown in Table 1 below:

TABLE 1
Concentrated Nanoemulsion Formulations

| | Nanoemulsion | Nanoemulsion | Nanoemulsion | Nanoemulsion |
|---|---|---|---|---|
| Actives | Formulation 1 | Formulation 2 | Formulation 3 | Formulation 4 |
| TWEEN 80 | 25.0% by weight | 50.0% by weight | 25.0% by weight | 50.0% by weight |
| Food Grade | 10% by weight | 20% by weight | 10% by weight | 20% by weight |
| Ethanol | | | | |
| Italian | 5.0% by weight | 10.0% by weight | | |
| Oregano | | | | |
| Essential Oil | | | | |
| Italian Garlic | | | 5.0% by weight | 10% by weight |
| Essential Oil | | | | |
| Water | Balance | Balance | Balance | Balance |

Although it is possible to form nanoemulsions from such components, the use of such high levels of ethanol is undesirable, the use of TWEEN 80 was found to result in an “oily” aftertaste, and when incorporated into a salad dressing, the garlic oil is present at such small droplet sizes that the garlic flavor is perceived near the beginning of the palatal response, which is also undesirable. Table 2 below describes such sample salad dressing formulations made from a nanoemulsion similar to Formulation 1. The nanoemulsion dressing formulations were created by making the nanoemulsion first and then adding the nanoemulsion into the oil phase of the dressing formulation before the entire dressing ingredients were mixed together.

TABLE 2
Control Dressing and Nanoemulsion Dressing Formulations

| | | Oregano Salad | Oregano Salad |
|---|---|---|---|
| | Control Salad | Dressing | Dressing |
| | Dressing | 0.13% by wt | 0.07% by wt |
| Ingredients | Weight % | Nanoemulsion | Nanoemulsion |
| Water | 31-43 | 40.85 | 40.85 |
| Salt | 2-4 | 1.60 | 1.60 |
| Egg Yolk | 2-4 | 2.00 | 2.00 |
| Buttermilk Flavor | 2-4 | 0.20 | 0.20 |
| Sugar | 2.2-3.7 | 2.75 | 2.75 |
| Flavor Enhancers | 0.0001-2.0 | 0.45 | 0.45 |
| (MSG, ribotides) | | | |
| Spices (mustard, | 0.0001-2.0 | 1.19 | 1.19 |
| parsley, black pepper) | | | |
| Onion and Garlic | 0.0001-2.0 | 0.50 | 0.50 |
| Powder | | | |
| Disodium Phosphate | 0.0001-2.0 | 0.10 | 0.10 |
| Natural and Artifical | 0.0001-2.0 | | |
| Flavors | | | |
| Thickeners (xanthan | 0.0001-2.0 | 0.22 | 0.22 |
| gum and modified | | | |
| food starch) | | | |
| Food Grade Acids | 0.0001-2.0 | 1.20 | 1.20 |
| (vinegar and | | | |
| phosphoric) | | | |
| Soybean Oil | 39-51 | 40.00 | 40.00 |
| Oregano Oil | | 0.13 | 0.07 |
| Nanoemulsion | | | |

The following formulations in Table 3 and Table 4 were created using an essential oil or nanoemulsion formulation and salad dressing control as shown in Table 2. The tasting test was performed using 5 tasters. The tasters tested Sample No. 1a and Sample No. 1b and used those samples as a standard of comparison for the other samples in the test. The results are recorded in plus signs when the flavor was stronger than the standard sample. The results are recorded in minus signs to show the sample was weaker than the standard sample. The equal sign shows that the taster indicated the sample was comparable to the standard sample 1a or 1b.

TABLE 3
Taste Test Oregano Salad Dressing Formulations

| | Italian Oregano | | | | | |
|---|---|---|---|---|---|---|
| | Essential Oil + | | | | | |
| | 500 g Salad | | | | | |
| Sample | Dressing | | | | | |
| No. | Control | Tester 1 | Tester 2 | Tester 3 | Tester 4 | Tester 5 |
| 1a | Oregano Oil | standard | standard | standard | standard | standard |
| | Nanoemulsion | | | | | |
| | 0.004% by | | | | | |
| | weight | | | | | |
| | (tasting | | | | | |
| | standard) | | | | | |
| 2a | Oregano Oil | − | − | − | − | − |
| | 0.004% by | | | | | |
| | weight | | | | | |
| 3a | Oregano Oil | − | − | = | − | − |
| | 0.08% by | | | | | |
| | weight | | | | | |
| 4a | Oregano Oil | + | = | + | = | = |
| | 0.025% by | | | | | |
| | weight | | | | | |
| 5a | Oregano Oil | = | = | = | = | = |
| | Nanoemulsion | | | | | |
| | 0.004% by | | | | | |
| | weight | | | | | |

The results show that each of the five testers found the taste of the regular essential oil composition at 0.004% was weaker than that of the nanoemulsion composition with the same amount of oregano essential oil. Furthermore four of the testers found that the standard essential oil at 0.008% was also weaker than the nanoemulsion composition with half of the amount of essential oil, 0.004%. In addition three of the testers thought the composition with 0.025% standard essential oil was comparable to the nanoemulsion composition at 0.004%. This taste test shows that the nanoemulsion composition at 0.004% oregano essential oil appears stronger than standard essential oil compositions with the same amount of essential oil and even appears stronger than essential oil compositions with two or more times the amount of essential oil.

Table 4 is similar to Table 3 in that it uses the same format for testing similar samples of garlic essential oil formulations against a comparable nanoformulation of garlic oil with a salad dressing base. The same plus, minus and equal signs are used for reporting the testing results of the tasters.

TABLE 4
Taste Test Garlic Salad Dressing Formulations

| | Garlic Essential | | | | | |
|---|---|---|---|---|---|---|
| | Oil + 500 g | | | | | |
| Sample | Salad Dressing | | | | | |
| No. | Base | Tester 1 | Tester 2 | Tester 3 | Tester 4 | Tester 5 |
| 1b | Garlic Oil | standard | standard | standard | standard | standard |
| | Nanoemulsion | | | | | |
| | 0.005% by | | | | | |
| | weight | | | | | |
| | (tasting | | | | | |
| | standard) | | | | | |
| 2b | Garlic Oil | − | − | − | − | − |
| | 0.005% by | | | | | |
| | weight | | | | | |
| 3b | Garlic Oil | − | − | − | − | − |
| | 0.009% by | | | | | |
| | weight | | | | | |
| 4b | Garlic Oil | − | = | = | − | − |
| | 0.015% by | | | | | |
| | weight | | | | | |
| 5b | Garlic Oil | = | = | + | = | + |
| | Nanoemulsion | | | | | |
| | 0.005% by | | | | | |
| | weight | | | | | |

The results show that each of the five testers found the taste of the regular essential oil composition at 0.005% and at 0.009% were both weaker than that of the nanoemulsion composition with 0.005% garlic essential oil. Furthermore three of the testers found that the standard garlic essential oil at 0.015% was comparable to the nanoemulsion composition with about one third the amount of garlic essential oil, 0.005%. This taste test shows that the nanoemulsion composition at 0.005% garlic essential oil provides stronger flavor to standard essential oil compositions with the same amount of essential oil and even appears stronger than essential oil compositions with two or more times the amount of essential oil.

The taste test results show that the dressing formulations with nanoemulsions provide flavor strength comparable to dressing formulations with at least twice the amount of essential oil flavorants. There is a significant cost savings associated with using less essential oil in a dressing formulation or other suitable food emulsions. In addition, the nanoemulsions with encapsulated flavorants, (e.g., essential oils) showed better stability and less oxidation in comparison with standard nanoemulsion compositions. The compositions in Table 3 and Table 4 were evaluated by a tasting panel after seven months and twelve months storage at room temperature. At seven months each of the standard, non-encapsulated flavorant dressing formulations showed the typical signs of oxidation and deterioration including rancid aroma and/or bitter flavor. In comparison, the dressing formulations with the nanoencapsulated flavorant(s) did not show any of the typical signs of oxidation and deterioration even after twelve months of storage at room temperature. From the stability testing it appears that the nanoemulsion formulations provide better overall stability for dressing formulations and prevent oxidative degradation of the components that leads to rancid odor and bitter flavor.

While the above examples showed that a nanoemulsion could be formed that provided improved stability and enhanced flavor characteristics (i.e., equal or stronger flavor with less flavorant), the examples are undesirable relative to other characteristics as they include high levels of ethanol, and the onion/garlic/oregano flavor is injected into the palatal response at or near the beginning rather than at or near the end of the palatal response, which is what is desired.

Tables 5-7 show additional examples that include a sugar alcohol and little or no ethanol. Such examples were made to better understand the phase characteristics of systems including the various contemplated components. As indicated in tables 5-7, such phase diagram studies are typically done while measuring volumetric ratios of the components. One may readily convert from volumetric fractions or ratios to weight fractions or ratios where the density of the component is known.

Such systems, and those which follow in Tables 8-10, begin to solve the above identified problems not addressed by the comparative examples above. Although stable single phase structures can be achieved as seen in some of the samples of Tables 5-7, the sorbitol to oil ratio is still relatively low (e.g., only about 2.24:1), so that while such nanoemulsion compositions can be formed that are stable, etc., these compositions exhibit smaller than desired droplet sizes, and the associated problems with palatal response. Further experiments conducted in accordance with some of the examples of Tables 8-10 lead to the surprising discovery that higher sorbitol to oil ratios can solve this problem. The components of the various examples used were generally 100% active with the exception of the sorbitol, which included 70% active sorbitol by weight (30% was water).

TABLE 5
Sorbitol Containing Compositions at 35° F.

| | Water | Onion oil | TWEEN 20 | Sorbitol | EtOH | Surf:Oil | Sorbitol:Oil | |
|---|---|---|---|---|---|---|---|---|
| Sample | (ml) | (ml) | (ml) | (ml) | (ml) | Vol. Ratio | Wt. Ratio | Result |
| F1 | 9.04 | 0.05 | 0.75 | 0.08 | 0.08 | 15:1 | 2.24:1 | 2 phase |
| F2 | 8.99 | 0.05 | 0.80 | 0.08 | 0.08 | 16:1 | 2.24:1 | 2 phase |
| F3 | 8.94 | 0.05 | 0.85 | 0.08 | 0.08 | 17:1 | 2.24:1 | 2 phase |
| F4 | 8.89 | 0.05 | 0.90 | 0.08 | 0.08 | 18:1 | 2.24:1 | 2 phase |
| F5 | 8.84 | 0.05 | 0.95 | 0.08 | 0.08 | 19:1 | 2.24:1 | 2 phase |
| F6 | 8.79 | 0.05 | 1.0 | 0.08 | 0.08 | 20:1 | 2.24:1 | 2 phase |
| F7 | 8.74 | 0.05 | 1.05 | 0.08 | 0.08 | 21:1 | 2.24:1 | 2 phase |
| F8 | 8.69 | 0.05 | 1.10 | 0.08 | 0.08 | 22:1 | 2.24:1 | 2 phase |
| F9 | 8.64 | 0.05 | 1.15 | 0.08 | 0.08 | 23:1 | 2.24:1 | 2 phase |
| F10 | 8.59 | 0.05 | 1.20 | 0.08 | 0.08 | 24:1 | 2.24:1 | 2 phase |
| F11 | 8.54 | 0.05 | 1.25 | 0.08 | 0.08 | 25:1 | 2.24:1 | 2 phase |
| F12 | 8.49 | 0.05 | 1.30 | 0.08 | 0.08 | 26:1 | 2.24:1 | 2 phase |
| F13 | 8.44 | 0.05 | 1.35 | 0.08 | 0.08 | 27:1 | 2.24:1 | 2 phase |
| F14 | 8.39 | 0.05 | 1.40 | 0.08 | 0.08 | 28:1 | 2.24:1 | 2 phase |
| F15 | 8.34 | 0.05 | 1.45 | 0.08 | 0.08 | 29:1 | 2.24:1 | 1 phase |
| F16 | 8.29 | 0.05 | 1.50 | 0.08 | 0.08 | 30:1 | 2.24:1 | 1 phase |

TABLE 6
Sorbitol Containing Compositions at 70° F.

| | Water | Onion oil | TWEEN 20 | Sorbitol | EtOH | Surf:Oil | Sorbitol:Oil | |
|---|---|---|---|---|---|---|---|---|
| Sample | (ml) | (ml) | (ml) | (ml) | (ml) | Vol. Ratio | Wt. Ratio | Result |
| G1 | 9.04 | 0.05 | 0.75 | 0.08 | 0.08 | 15:1 | 2.24:1 | 2 phase |
| G2 | 8.99 | 0.05 | 0.80 | 0.08 | 0.08 | 16:1 | 2.24:1 | 2 phase |
| G3 | 8.94 | 0.05 | 0.85 | 0.08 | 0.08 | 17:1 | 2.24:1 | 2 phase |
| G4 | 8.89 | 0.05 | 0.90 | 0.08 | 0.08 | 18:1 | 2.24:1 | 2 phase |
| G5 | 8.84 | 0.05 | 0.95 | 0.08 | 0.08 | 19:1 | 2.24:1 | 2 phase |
| G6 | 8.79 | 0.05 | 1.0 | 0.08 | 0.08 | 20:1 | 2.24:1 | 2 phase |
| G7 | 8.74 | 0.05 | 1.05 | 0.08 | 0.08 | 21:1 | 2.24:1 | 2 phase |
| G8 | 8.69 | 0.05 | 1.10 | 0.08 | 0.08 | 22:1 | 2.24:1 | 2 phase |
| G9 | 8.64 | 0.05 | 1.15 | 0.08 | 0.08 | 23:1 | 2.24:1 | 2 phase |
| G10 | 8.59 | 0.05 | 1.20 | 0.08 | 0.08 | 24:1 | 2.24:1 | 2 phase |
| G11 | 8.54 | 0.05 | 1.25 | 0.08 | 0.08 | 25:1 | 2.24:1 | 2 phase |
| G12 | 8.49 | 0.05 | 1.30 | 0.08 | 0.08 | 26:1 | 2.24:1 | 1 phase |
| G13 | 8.44 | 0.05 | 1.35 | 0.08 | 0.08 | 27:1 | 2.24:1 | 1 phase |
| G14 | 8.39 | 0.05 | 1.40 | 0.08 | 0.08 | 28:1 | 2.24:1 | 1 phase |
| G15 | 8.34 | 0.05 | 1.45 | 0.08 | 0.08 | 29:1 | 2.24:1 | 1 phase |
| G16 | 8.29 | 0.05 | 1.50 | 0.08 | 0.08 | 30:1 | 2.24:1 | 1 phase |

TABLE 7
Sorbitol Containing Compositions at 100° F.

| | Water | Onion oil | TWEEN 20 | Sorbitol | EtOH | Surf:Oil | Sorbitol:Oil | |
|---|---|---|---|---|---|---|---|---|
| Sample | (ml) | (ml) | (ml) | (ml) | (ml) | Vol. Ratio | Wt. Ratio | Result |
| H1 | 9.04 | 0.05 | 0.75 | 0.08 | 0.08 | 15:1 | 2.24:1 | 2 phase |
| H2 | 8.99 | 0.05 | 0.80 | 0.08 | 0.08 | 16:1 | 2.24:1 | 2 phase |
| H3 | 8.94 | 0.05 | 0.85 | 0.08 | 0.08 | 17:1 | 2.24:1 | 1 phase |
| H4 | 8.89 | 0.05 | 0.90 | 0.08 | 0.08 | 18:1 | 2.24:1 | 1 phase |
| H5 | 8.84 | 0.05 | 0.95 | 0.08 | 0.08 | 19:1 | 2.24:1 | 1 phase |
| H6 | 8.79 | 0.05 | 1.0 | 0.08 | 0.08 | 20:1 | 2.24:1 | 1 phase |
| H7 | 8.74 | 0.05 | 1.05 | 0.08 | 0.08 | 21:1 | 2.24:1 | 1 phase |
| H8 | 8.69 | 0.05 | 1.10 | 0.08 | 0.08 | 22:1 | 2.24:1 | 1 phase |
| H9 | 8.64 | 0.05 | 1.15 | 0.08 | 0.08 | 23:1 | 2.24:1 | 1 phase |
| H10 | 8.59 | 0.05 | 1.20 | 0.08 | 0.08 | 24:1 | 2.24:1 | 1 phase |
| H11 | 8.54 | 0.05 | 1.25 | 0.08 | 0.08 | 25:1 | 2.24:1 | 1 phase |
| H12 | 8.49 | 0.05 | 1.30 | 0.08 | 0.08 | 26:1 | 2.24:1 | 1 phase |
| H13 | 8.44 | 0.05 | 1.35 | 0.08 | 0.08 | 27:1 | 2.24:1 | 1 phase |
| H14 | 8.39 | 0.05 | 1.40 | 0.08 | 0.08 | 28:1 | 2.24:1 | 1 phase |
| H15 | 8.34 | 0.05 | 1.45 | 0.08 | 0.08 | 29:1 | 2.24:1 | 1 phase |
| H16 | 8.29 | 0.05 | 1.50 | 0.08 | 0.08 | 30:1 | 2.24:1 | 1 phase |

Density of the onion oil was about 1.07 g/ml. Density of TWEEN 20 was about 1.1 g/ml. Density of ethanol was about 0.79 g/ml. Density of sorbitol was about 1.5 g/cm³. These values could be used to switch between volumetric and weight ratios of the various components. It was observed that relative to earlier formulations, the inclusion of sorbitol aided in stabilization of the nanoemulsion. The inclusion of ethanol was also observed to aid in stabilization, although the inclusion of ethanol in some embodiments is less preferred for reasons discussed above. The above embodiments include less than 1% by weight ethanol. As can be seen by a comparison of the data of Tables 5-7, temperature has a significant effect on phase stability for many of the tested formulations. Relatively dilute aqueous systems required higher surfactant/oil ratios to maintain a stable nanoemulsion phase.

Additional formulations (see Table 8) were prepared to assess the effect of sorbitol concentration in manipulating droplet size. As can readily be seen from the data in Table 8, the droplet sizes increase as the concentration of sorbitol within the nanoemulsion is also increased. It is believed that sugar alcohols such as sorbitol act as a kosmotrope to break the lamellar phase when added to a mixture of the oil and surfactant, which aids in formation of the desired microemulsion concentrate that may be phase inverted upon dilution with water to produce the desired nanoemulsion. Often, the drive in nanoemulsion formulation would be to achieve smaller and smaller droplet sizes to maximize flavoring effect of the flavorant (i.e., maximize surface area to volume ratio). In contrast, here it was discovered that by actually backing away somewhat from the smallest median droplet size achievable, the problem of insertion of the flavorant into the palatal response at an incorrect stage could be addressed.

The Examples of Table 8 include 1 weight percent oil flavorant (i.e., garlic or onion, respectively), 22 weight percent TWEEN, no ethanol, and the balance water. The Examples of Table 8 clearly show that increasing the amount of sorbitol causes an increase in mean or median droplet size. Mean droplet size was measured using TEM.

TABLE 8
Effect of Sorbitol on Droplet Size

| Sample | Flavorant | Percent Sorbitol (wt) | Droplet Size (nm) |
|---|---|---|---|
| 8-1 | Garlic oil | 2 | 21 |
| 8-2 | Onion oil | 2 | 27 |
| 8-3 | Garlic oil | 15 | 35 |
| 8-4 | Onion oil | 15 | 39 |
| 8-5 | Garlic oil | 30 | 71 |
| 8-6 | Onion oil | 30 | 70 |

Additional formulations (see Table 9) were prepared including low or no levels of ethanol and at different sorbitol concentrations and tested to confirm stability once incorporated into a salad dressing similar to the formula shown in Table 2. Each of the four different samples were stored at 35° F., 70° F., and 100° F. for a period of 3 months and their stability compared to a control having a salad dressing formulation similar to that shown in Table 2. Each sample was also frozen, and stability assessed after the 3 month period. In addition, each of the four samples was tested at 3 different dilution ratios (no dilution, 1:25 dilution, and 1:50 dilution) for temperature and freezing stability. The diluted garlic oil samples of Table 9 were visually clear at all temperatures for the entire 3 months. The Examples of Table 9 include 20% to 22% TWEEN 20, and the balance water.

TABLE 9
Additional Stable Garlic Oil Examples

| Sample | Flavorant | Percent Sorbitol (wt) | Percent EtOH |
|---|---|---|---|
| 9-1 | 1% Garlic oil | 2 | 0 |
| 9-2 | 1% Garlic oil | 15 | 0 |
| 9-3 | 1% Garlic oil | 2 | 4 |
| 9-4 | 1% Garlic oil | 15 | 4 |

Additional formulations (see Table 10) were prepared including low or no levels of ethanol and at different sorbitol concentrations and tested to confirm stability once incorporated into a salad dressing similar to the formula shown in Table 2. Each of the four different samples were stored at 35° F., 70° F., and 100° F. for a period of 3 months and their stability was compared to a control having a salad dressing formulation similar to that shown in Table 2. Each sample was also frozen, and stability assessed after the 3 month period. In addition, each of the four samples was tested at 3 different dilution ratios (no dilution, 1:25 dilution, and 1:50 dilution) for temperature and freezing stability. The diluted onion samples of Table 10 were visually clear at all temperatures for the entire 3 months. Only the concentrated onion sample turned cloudy, after about one week. The Examples of Table 10 include 7.2% TWEEN 20, and the balance water.

TABLE 10
Additional Stable Onion Oil Examples

| Sample | Flavorant | Percent Sorbitol (wt) | Percent EtOH |
|---|---|---|---|
| 10-1 | 0.33% Onion oil | 2 | 0 |
| 10-2 | 0.33% Onion oil | 15 | 0 |
| 10-3 | 0.33% Onion oil | 2 | 4 |
| 10-4 | 0.33% Onion oil | 15 | 4 |

As will be apparent from the examples of Tables 9 and 10, separate nanoemulsions may be provided for different flavors. This allows one to manipulate the median droplet size of each flavorant separately from each other flavorant so as to better control the palatal response provided when two or more flavorant nanoemulsion compositions are incorporated into a food product. Embodiments of the food emulsion composition of the present invention may be used in a concentrated nanoemulsion to be added to food or it can be provided in a diluted form as already added into a food (e.g., a salad dressing) or beverage product.

Some food products that can incorporate food nanoemulsion composition embodiments of the present invention include prepared frozen microwaveable and steamed meals and other heat and eat frozen snacks, sport drinks, sauces, and condiments. Some examples of food nanoemulsion composition embodiments of the present invention include natural flavor enhancers for foods, such as natural flavor cheeses, refrigerated pizza, flavor enhancers for roasting meets and chicken, and water enhancers. Embodiments of the present invention can also be used with aseptic process foods using indirect heating and direct heating in the form of steam infusion or steam injection.

These various forms and the wide variety of flavorants which can be used to create a nanoemulsion composition provide a number of possibilities for compositions which would be in the spirit of the invention as described herein. For example, with different flavorants (e.g., other than onion and garlic), it may be desirable to insert the oil flavorant into the palatal response earlier, in which case one could decrease the sugar alcohol to oil flavorant ratio to achieve the desired effect. While the present invention has been described with reference to what are presently considered to be the preferred embodiments, it is to be understood that the invention is not limited to these embodiments. To the contrary, the invention is intended to cover various modifications and equivalent arrangements included within the spirit and scope of the appended claims.

We claim:

1. A food nanoemulsion composition comprising:
(a) a hydrophobic food flavorant that is oil-based and natural;
(b) a food safe nonionic surfactant provided at a weight ratio of at least 5:1 relative to said hydrophobic food flavorant;
(c) a food grade sugar alcohol kosmotrope provided at a weight ratio of at least 8:1 relative to said hydrophobic food flavorant; and
(d) water;
(e) wherein the hydrophobic food flavorant has a median droplet size between 50 nm and 100 nm and the composition is substantially free of polyols other than the sugar alcohol.

2. The food nanoemulsion composition of claim 1, wherein the hydrophobic food flavorant is selected from the group consisting of an essential oil and an oleoresin.

3. The food nanoemulsion composition of claim 1, wherein the food safe nonionic surfactant comprises a polysorbate.

4. The food nanoemulsion composition of claim 3, wherein the food safe nonionic surfactant comprises polyoxyethylene sorbitan monolaurate.

5. The food nanoemulsion composition of claim 1, wherein the sugar alcohol comprises a food grade sugar alcohol selected from the group consisting of: sorbitol, xylitol, arabitol, lactitol, maltitol, glycerol, mannitol, isomalt, erythritol, dulcitol, iditol, polyglycitol, and mixtures thereof.

6. The food nanoemulsion composition of claim 1, wherein the food grade sugar alcohol is sorbitol.

7. The food nanoemulsion composition of claim 1, wherein the nanoemulsion includes no more than 5% ethanol.

8. The food nanoemulsion composition of claim 7, wherein the nanoemulsion is void of ethanol.

9. The food nanoemulsion composition of claim 1, wherein the composition has a median droplet size between 60 nm and 80 nm.

10. The food nanoemulsion composition of claim 9, wherein the nanoemulsion composition is sufficiently thermodynamically stable that it can be boiled, frozen and dried while maintaining its nanoemulsion structure.

11. The food nanoemulsion composition of claim 1, wherein the ratio of sugar alcohol to hydrophobic flavorant is specifically selected to achieve a desired median droplet size so as to provide a desired palatal response.

12. The food nanoemulsion composition of claim 12, wherein the hydrophobic flavorant is encapsulated within the food nanoemulsion structure such that it is protected against oxidation and deterioration by a physical barrier that minimizes the flavorant's interaction with oxygen.

13. A food product containing a nanoemulsion flavorant composition comprising:
(a) a food product; and
(b) a flavoring component that comprises a nanoemulsion composition;
wherein the nanoemulsion composition comprises
(1) a hydrophobic food flavorant that is oil-based and natural,
(2) a polyoxyethylene sorbitan monolaurate surfactant provided at a weight ratio of at least 5:1 relative to said hydrophobic food flavorant,
(3) a food grade sugar alcohol kosmotrope provided at a weight ratio of at least 8:1 relative to said hydrophobic food flavorant, and
(4) water,
wherein the hydrophobic food flavorant has a median droplet size between 50 nm and 100 nm and the composition is substantially free of polyols other than the sugar alcohol.

14. The food product containing a nanoemulsion flavorant composition of claim 13, wherein the food grade sugar alcohol is selected from the group consisting of: sorbitol, xylitol, arabitol, lactitol, maltitol, glycerol, mannitol, isomalt, erythritol, dulcitol, iditol, polyglycitol, and mixtures thereof.

15. The food product containing a nanoemulsion flavorant composition of claim 13, wherein the food grade sugar alcohol is sorbitol.

16. The food product containing a nanoemulsion flavorant composition of claim 13, wherein the nanoemulsion flavorant composition is void of ethanol.

17. The food product containing a nanoemulsion flavorant composition of claim 13, wherein the hydrophobic flavorant has a median droplet size between 60 nm and 80 nm.

18. The food product containing a nanoemulsion flavorant composition of claim 13, wherein the food product is a salad dressing, a frozen microwaveable meal, a frozen steamable meal, a frozen snack, a sport drink, a sauce, and a condiment; and wherein the nanoemulsion flavorant composition is sufficiently thermodynamically stable that the hydrophobic flavorant does not develop rancid odors or bitter tastes for a period of at least twelve months.

19. A food water-in-oil microemulsion concentrate composition comprising:
(a) a hydrophobic food flavorant that is oil-based and natural;
(b) a food safe nonionic surfactant provided at a weight ratio of at least 5:1 relative to said hydrophobic food flavorant;
(c) a food grade sugar alcohol kosmotrope provided at a weight ratio of at least 8:1 relative to said hydrophobic food flavorant; and
(d) water;
(e) wherein the microemulsion concentrate phase inverts from a water-in-oil emulsion to an oil-in-water emulsion upon dilution with water to form a nanoemulsion flavorant composition containing hydrophobic food flavorants having a median droplet size between 50 nm and 100 nm.
